(19) United States
(12) Patent Application Publication
(10) Pub. No.: US 2021/0341883 A1
(43) Pub. Date: Nov. 4, 2021

(54) METHOD OF CONFIGURING TIMER AND TIMER USING THE METHOD

(71) Applicant: MELIKE INC, Seoul (KR)

(72) Inventor: Hee seung Chung, (US)

(21) Appl. No.: 16/964,146

(22) PCT Filed: Jun. 27, 2019
(86) PCT No.: PCT/KR2019/007839

§ 371 Date: Jul. 22, 2020

(30) Foreign Application Priority Data
Jan. 25, 2019 (KR) 10-2019-0009976

(51) Int. Cl. G04F 1/00; G04F 7/08; G04F 3/08; G04G 9/00

(52) U.S. Cl. CPC G04F 1/005; G04G 9/0041; G04F 3/08; G04F 7/089

(57) ABSTRACT

The present invention relates to a timer configuring method and a timer using the same. The timer configuring method includes receiving, by a timer, a target time, and changing, by the timer, an area of a time display region on the basis of the target time and counting the target time. The area of the time display region is changed by rotation of a plurality of time display structures.

### TECHNICAL FIELD

The present invention relates to a timer configuring method and a timer using the same, and more specifically, to a method and apparatus for increasing a time recognition effect through a timer of a user by visually expressing an elapse of a set time on the timer.

### BACKGROUND ART

For modern people who are restrained by clocks and calendars, efficient achievement of goals within a given time is an important issue.

Time management can be defined in various ways depending on a situation and can include doing the right thing at the right time, distributing time appropriately between work and leisure, performing planned procedures to achieve desirable goals, and using time efficiently, and furthermore, include managing and controlling the overall aspect of life.

Depending on time management skills, there may be differences in work efficiency and work performance even within the same time period. In addition, time management can increase self-efficacy, which can affect future work.

Currently, various applications or tools are used for time management, but tools are needed to aid users in managing their time more effectively.

### DISCLOSURE

### Technical Problem

The present invention is directed to solving all the above-described problems.

The present invention is also directed to setting a necessary time based on a short-range communication technology and visually providing the set time to a user.

The present invention is also directed to aiding users in managing their time and achieving their goals by managing an immersion time based on a timer.

The present invention is also directed to managing a plurality of divided times based on a time display region of one timer.

### Technical Solution

Representative configurations of the present invention for achieving the above objects are as follows.

One aspect of the present invention provides a timer configuring method. The timer configuring method includes receiving, by a timer, a target time, and changing, by the timer, an area of a time display region on the basis of the target time and counting the target time. The area of the time display region is changed by rotation of a plurality of time display structures.

One aspect of the present invention provides a timer including a communication unit implemented to receive a target time, and a timer driver implemented to change an area of a time display region on the basis of the target time and count the target time. The area of the time display region is changed by rotation of a plurality of time display structures.

### Advantageous Effects

According to the present invention, a necessary time can be set based on a short-range communication technology and the set time can be visually provided to a user.

Further, users can easily manage their time and achieve their goals by managing an immersion time based on a timer.

In addition, a plurality of divided times can be managed based on a time display region of one timer.

### DESCRIPTION OF DRAWINGS

FIG. 1 is a conceptual diagram illustrating a timer according to an embodiment of the present invention.

FIG. 2 is a conceptual diagram illustrating an operation of a timer display according to an embodiment of the present invention.

FIG. 3 is a conceptual diagram illustrating an operation of a timer display according to an embodiment of the present invention.

FIG. 4 is a conceptual diagram illustrating a timer configuring method according to an embodiment of the present invention.

FIG. 5 is a conceptual diagram illustrating a method of measuring an immersion time based on a timer according to an embodiment of the present invention.

FIG. 6 is a conceptual diagram illustrating a method of measuring an immersion time by category according to an embodiment of the present invention.

FIG. 7 is a conceptual diagram illustrating a method of setting a timer display according to an embodiment of the present invention.

FIG. 8 is a conceptual diagram illustrating a method of correcting an immersion time based on a timer according to an embodiment of the present invention.

FIG. 9 is a conceptual diagram illustrating a method of providing an alarm for a deadline on a timer according to an embodiment of the present invention.

FIG. 10 is a conceptual diagram illustrating a method of determining a priority of a deadline according to an embodiment of the present invention.

FIG. 11 is a conceptual diagram illustrating a method of determining a priority of a deadline according to an embodiment of the present invention.

### MODES OF THE INVENTION

Detailed descriptions of the present invention will be made with reference to the accompanying drawings illustrating specific embodiments of the present invention as examples. These embodiments will be described in detail such that the present invention can be performed by those skilled in the art. It should be understood that various embodiments of the present invention are different but are not necessarily mutually exclusive. For example, a specific shape, structure, and characteristic of an embodiment described herein may be implemented in another embodiment without departing from the scope and spirit of the present invention. In addition, it should be understood that a position or an arrangement of each component in each disclosed embodiment may be changed without departing from the scope and spirit of the present invention. Accordingly, there is no intent to limit the present invention to detailed descriptions to be described below. The scope of the present invention is defined by the appended claims and encompasses all equivalents that fall within the scope of the appended claims. Like numbers refer to equal or like functions throughout the description of the figures.

Hereinafter, in order for those skilled in the art to easily perform the present invention, exemplary embodiments of the present invention will be described in detail with reference to the accompanying drawings.

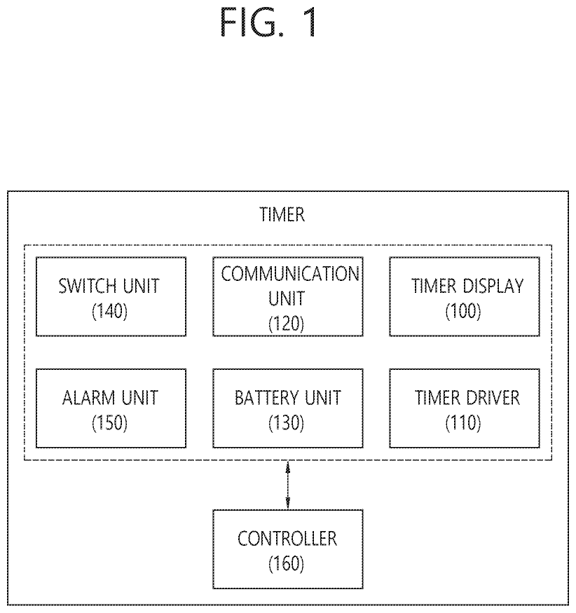

FIG. 1 is a conceptual diagram illustrating a timer according to an embodiment of the present invention.

Referring to FIG. 1, the timer may include a timer display 100, a timer driver 110, a communication unit 120, a battery unit 130, a switch unit 140, an alarm unit 150, and a controller 160.

The timer driver 110 may be implemented as a motor for driving the timer. For example, the timer driver 110 may drive the timer display 100 to change the display of time on the timer display 100 on the basis of a set time.

The timer driver 110 may drive the timer display 100 according to a target time using a time setting card for time setting. For example, when the time which is set using the time setting card is a first time, a change from a start time point to an end time point of the set first time may be visually expressed according to the change in time by changing the movement of a first time display structure and/or a second time display structure in the timer display 100 at time change intervals (e.g., one minute, one second, etc.) on the basis of the first time. In other words, a rotation speed of the first time display structure and/or the second time display structure in the timer display 100 may be changed according to the target time which is set using the time setting card.

The timer driver 110 may change the movement of the first time display structure and/or the second time display structure displayed on the timer display 100 at different time change intervals using the time setting card to induce a visual change in a time display region according to the target time.

The timer display 100 may be implemented to visually express a change in the target time. The timer display 100 may be implemented such that the time display region is visually changed according to a time change from a start time point to an end time point according to the target time based on the first time display structure and the second time display structure. The time display region may be filled with a specific color while being changed from a first color to a second color according to the change in time. For example, when the first time is 30 minutes, the time display region of the timer display may be displayed in the first color at a start time point of 30 minutes which is set and may express an elapse of the target time while being changed from the first color to the second color as the time moves from the start time point to the end time point. For example, at the start time point, 100% of the timer display 100 may be displayed in the first color, and 0% of the timer display 100 may be displayed in the second color. While moving from the start time point to the end time point, an area of the timer display 100 displayed in the first color may be changed from 100% to 0%, and an area of the timer display 100 displayed in the second color may be changed from 0% to 100%. At the end time point, 0% of the timer display 100 may be displayed in the first color, and 100% of the timer display 100 may be displayed in the second color.

The communication unit 120 may be implemented to enable communication with the time setting card. For example, the communication unit 120 may receive time setting information from the time setting card by communicating with a communication unit of the time setting card via short-range communication (e.g., near-field communication (NFC)). The time setting information received by the communication unit 120 may be transmitted to the timer driver 110 and used to determine the target time.

The battery unit 130 may be implemented to supply power to at least one component of the timer so that each component is operable.

The switch unit 140 may be implemented to transmit a start signal for counting of the set time. After the target time is set on the timer, a switch of the switch unit 140 may be pressed to start counting of the target time.

The alarm unit 150 may be implemented to provide an alarm signal related to the target time. For example, the alarm unit 150 may be implemented to notify the user of the start and end of counting of the target.

The controller 160 may be implemented to control operations of the timer driver 110, the timer display 100, the communication unit 120, the battery unit 130, the switch unit 140, and the alarm unit 150.

According to the embodiment of the present invention, it is assumed that the timer driver 110 displays a change in time on the timer display 100 by changing time display structures using a physical force such as a force generated from a motor. However, the timer display 100 may be implemented as an electronic display, such as a light-emitting diode (LED) display, rather than a mechanical structure, and such an embodiment may also be included in the scope of the present invention.

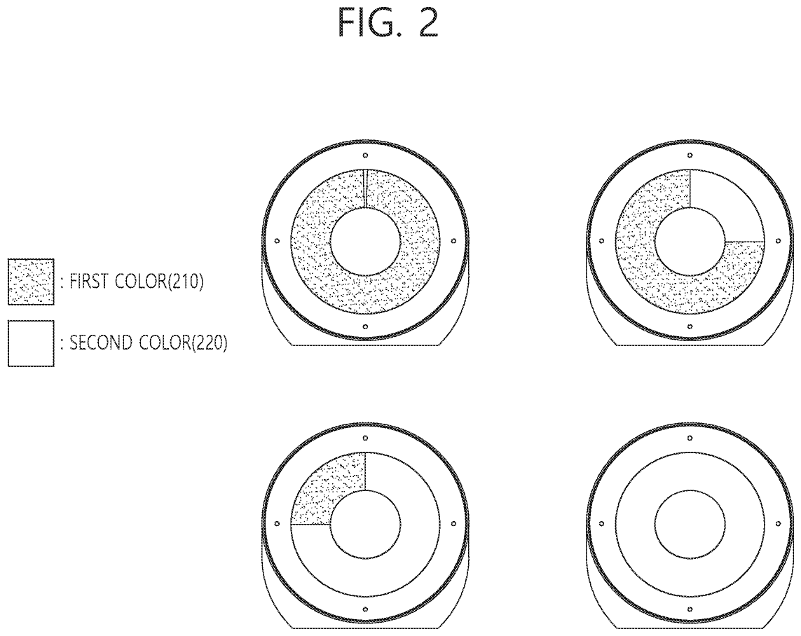

FIG. 2 is a conceptual diagram illustrating an operation of a timer display according to an embodiment of the present invention.

In FIG. 2, a method of changing a time display region on the timer display is disclosed.

Referring to FIG. 2, on the timer display, the time display region may be changed according to counting of a target time.

Specifically, when the target time is 30 minutes, the time display region in a concentric circle shape may be set as a first color 210 at a start time point of the target time.

The first color 210 may be changed to a second color 220 according to a change in time from the start time point to an end time point of the target time so that an elapse of the target time may be provided visually. Specifically, the first color 210 may be changed to the second color 220 based on a specific point of a concentric circle so that a change in the target time may be visually expressed.

A change rate from the first color 210 to the second color 220 may be determined by a time change interval according to the target time. For example, when the target time is a first time (e.g., 30 minutes), the time change interval may be set to a first interval so that the change rate from the first color 210 to the second color 220 may be determined as a first change rate, and when the set target time is a second time (e.g., one hour), the time change interval may be set to a second interval so that the change rate from the first color 210 to the second color 220 may be determined as a second change rate. The first change rate and the second change rate may be determined based on changes in the first time display structure and the second time display structure, respectively.

Through such a change in time, an entirety of the first color 210 may be changed to the second color 220 at the end time point of the target time.

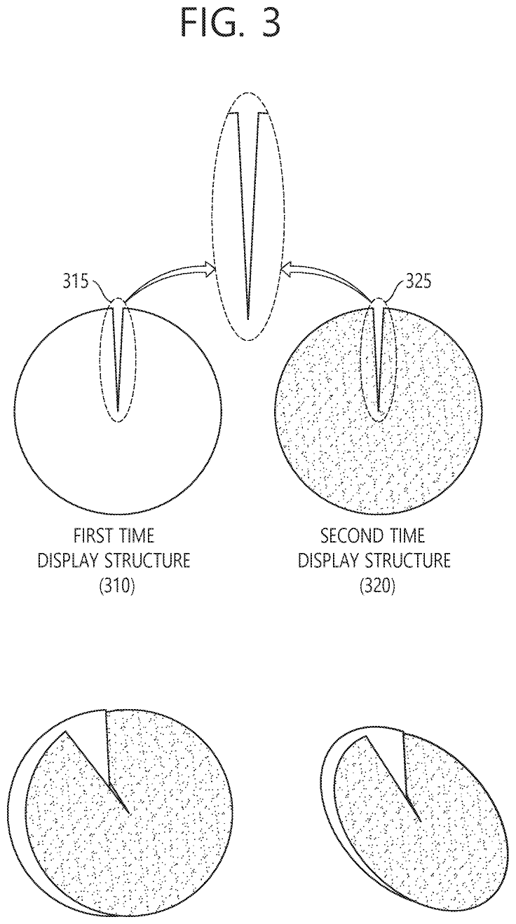

FIG. 3 is a conceptual diagram illustrating an operation of a timer display according to an embodiment of the present invention.

In FIG. 3, a method of expressing a change in a target time based on movement of a first time display structure and/or a second time display structure displayed on the timer display is disclosed.

Referring to FIG. 3, the timer driver may change movement (or a rotation speed) of a first time display structure 310 and/or a second time display structure 320 displayed on the timer display at different time change intervals using a time setting card.

The first time display structure 310 and the second time display structure 320 may be implemented as a circular shape, and the first time display structure 310 may have a first connection point 315 and the second time display structure 320 may have a second connection point 325.

The second time display structure 320 may be located on a top of the first time display structure 310, and the first connection point 315 of the first time display structure 310 and the second connection point 325 of the second time display structure 320 may meet.

A first surface of the first time display structure 310 may be located and rotated on a top of a second surface of the second time display structure 320 on the basis of the first connection point 315 and the second connection point 325 at a rotation angle by rotation of the first time display structure 310 and the second time display structure 320.

That is, by the rotation of the first time display structure 310 and/or the second time display structure 320, a state in which only the second surface is visible may be changed to a state in which the first surface of the first time display structure 310 covers the second surface of the second time display structure 320 so that the first surface gradually appears.

With the above principle, in consideration of the time change interval according to the change in the target time, the first time display structure 310 and/or the second time display structure 320 may be rotated, and a screen of the timer is changed from the second surface to the first surface so that an elapse of the target time may be displayed.

Specifically, when the target time is set, the second time display structure 320 may be in a state of being located on an upper surface of the first time display structure 310. In this case, the second surface of the second time display structure 320 may be displayed on the timer display.

When a start switch on the timer is pressed, the first surface of the first time display structure 310 may be moved to the top of the second surface of the second time display structure 320 by the rotation of the first time display structure 310 and/or the second time display structure 320 on the basis of the first connection point 315 and the second connection point 325, and thus the first surface of the first time display structure 310 may cover the second surface of the second time display structure 320.

The second surface displayed on the timer display is gradually changed to the first surface so that the elapse of the target time may be displayed. When the target time has elapsed, the first surface of the first time display structure 310 may be displayed on the timer display.

When the time is set again in the timer, the second time display structure 320 may be in a state of being located on the upper surface of the first time display structure 310 again.

The timer display may be displayed as a number but may be expressed as n segments and may perform a timer function by adjusting a movement angle per hour for any time setting.

According to the embodiment of the present invention, an additional third time display structure may be used for additional time display. The third time display structure includes a third connection point and the third time display structure is located on an upper surface of the second time display structure 320. Therefore, it is possible to display additional time ideas in an additional color through the third time display structure.

Further, according to the embodiment of the present invention, in order to set positions of the time display structures using the connection points on the time display structure, a position adjustment structure for adjusting the positions of the time display structures may be implemented on the timer. For example, when the start switch is pressed, the first surface of the first time display structure 310 may be moved to the upper end of the second surface of the second time display structure 320 by the rotation of the first time display structure 310 and/or the second time display structure 320 on the basis of the first connection point 315 and the second connection point 315, and thus the first surface of the first time display structure 310 should cover the second surface of the second time display structure 320. In order to facilitate the above operation, the position adjustment structure may adjust the angle and position of the second time display structure 320 and/or the second connection point and the angle and position of the first time display structure 310 and/or the first connection point such that the first surface of the first time display structure 310 may be moved to the upper end of the second surface of the second time display structure 320 by the rotation of the first time display structure 310 and/or the second time display structure 320.

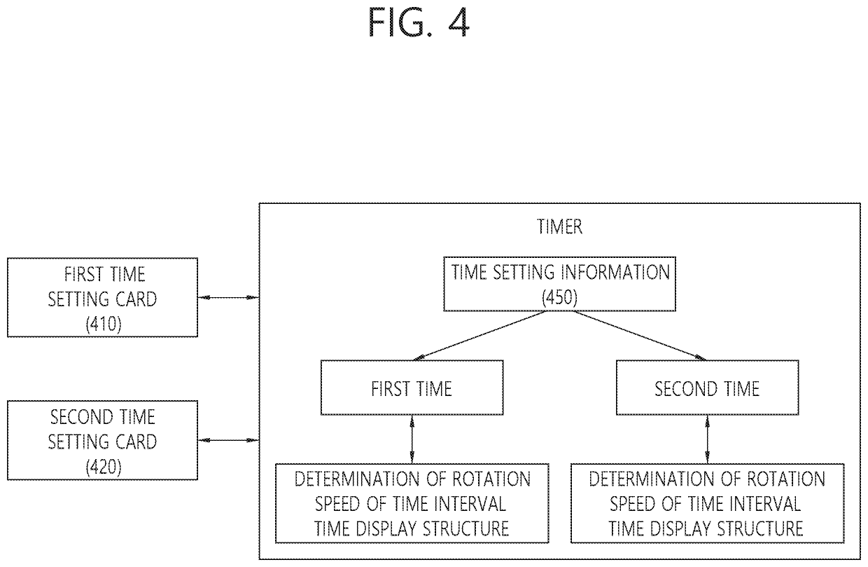

FIG. 4 is a conceptual diagram illustrating a timer configuring method according to an embodiment of the present invention.

In FIG. 4, a method of determining a target time on a timer according to a time setting card and determining a time change interval is disclosed.

Referring to FIG. 4, a time setting card may be a card for setting a time which will be set in the timer. For example, when a target time of a first time setting card 410 is 30 minutes and the first time setting card 410 is inserted into the timer, the timer may be set to 30 minutes. When a target time of a second time setting card 420 is one hour and the second time setting card 420 is inserted into the timer, the timer may be set to one hour.

As described above, when the time setting card is inserted into the timer, the communication unit may receive time setting information 450 from the time setting card by communicating with a communication unit of the time setting card via short-range communication (e.g., NFC). The time setting information 450 received by the communication unit may be transmitted to the timer driver and used to determine the target time.

When the time setting card is set to a first time, the timer driver may determine a time change interval (or a rotation speed of a time display structure) according to the first time and change the movement of the first time display structure and/or the second time display structure displayed on the timer display.

Further, when the time setting card is set to a second time, the timer driver may determine the time change interval (or the rotation speed of the time display structure) according to the second time and change the movement of the first time display structure and/or the second time display structure displayed on the timer display.

In the above-described embodiment, the method of determining the target time of the timer according to the time setting card by mechanically inserting the time setting card is disclosed. However, the target time of the timer may be determined using a timer application of a user device based on the communication unit. For example, a target time desired to be set through the timer may be determined using the timer application of the user device. When the timer target time is determined to be 30 minutes through a user interface of the timer application, information about the target time of the timer may be transmitted to the timer, the time change interval (or the rotation speed of the time display structure) of the timer may be determined and operated according to the information about the target time of the timer.

Further, the switch unit may be implemented such that a switch on the user interface can be pressed through the timer application on the user device rather than a physical switch and may determine the start and/or end of the timer.

Further, according to the embodiment of the present invention, a time that need to be set may be purchased through the timer application. In the case of a frequently used time, when a time (e.g., 30 minutes) is purchased and set, it is possible to set a time of 30 minutes on the timer through the timer application. The purchase of the time settable on the timer may be a one-time purchase and the purchased time may be used on the timer in one time, or the purchase of the time settable on the timer may be a permanent purchase and the purchased time may be continuously available on the timer. That is, it is possible to set the timer based on a timer card by purchasing a virtual timer card on the timer application rather than by using a separate NFC card.

Records of the time purchased through MyPage, the number of clicks (execution) of each target time, and the total amount of usage time may remain.

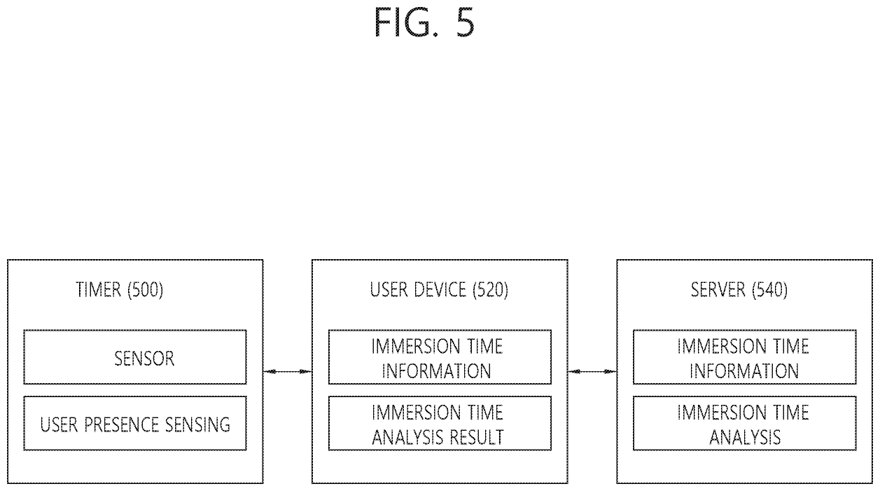

FIG. 5 is a conceptual diagram illustrating a method of measuring an immersion time based on a timer according to an embodiment of the present invention.

In FIG. 5, a method of measuring an immersion time, such as a user's learning time and work time, by utilizing a timer is disclosed. Hereinafter, for convenience of description, a time that the user sits on a seat measured using the timer may be expressed in terms of immersion time.

Referring to FIG. 5, when the user who uses the timer sits on a seat and presses a start button of a timer 500, the presence of the user who uses the timer may be sensed by a sensor and an immersion time of the user may be measured.

When the presence of the user is sensed by the sensor, the timer 500 may be operated and counting for time may be performed, and when the presence of the user is not sensed by the sensor, the timer 500 may not be operated and the counting for time may be stopped. When the user leaves the seat, the movement of the user may be sensed and the operation of the timer 500 may be stopped. In this way, the measurement of the time for which the user is immersed may be performed, and the user may check the immersion time using the timer 500.

The time measured using the timer 500 may be transmitted to a user device 520 through the communication unit. The user device 520 may receive information about a total amount of the immersion time of the user by the start and stop of the measurement of the timer 500 on the basis of the sensing of the presence of the user, and the information about the total amount of the immersion time may be stored in a server 540.

The information about the immersion time of the user may be provided to the user through a timer application of the user device 520. Further, the information about the immersion time of the user may be provided to the user through the timer application, and analysis information about an immersion pattern of the user, correction information about the immersion pattern, or the like may also be provided.

In addition, the information about the immersion time may be shared within a set group and used to encourage work and/or study between users in the group.

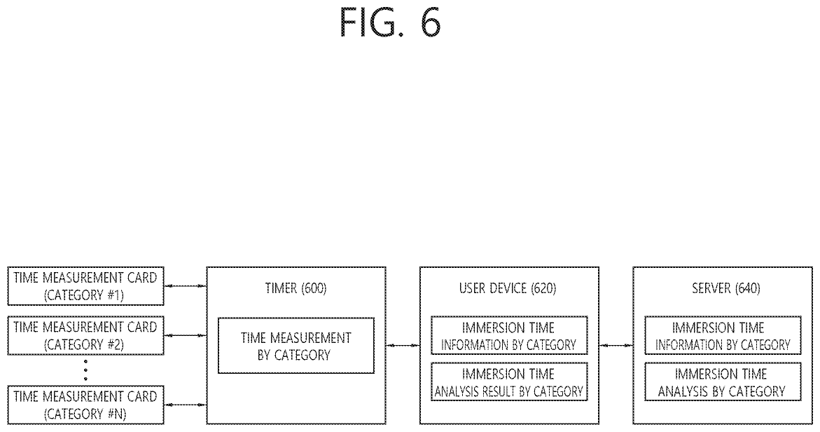

FIG. 6 is a conceptual diagram illustrating a method of measuring an immersion time by category according to an embodiment of the present invention.

In FIG. 6, the method of measuring an immersion time by category is disclosed.

Referring to FIG. 6, a time measurement card may be present for each category, and an immersion time may be measured according to the set category.

When a time measurement card (category #1) is inserted, an immersion time for category #1 may be measured. As described above in FIG. 5, a time measured by a timer 600 may be transmitted to a user device through a communication unit. In this case, information indicating that the time is for the category #1 may be additionally included and be transmitted to a user device 620. Information about a total amount of the immersion time for category #1 may be stored in a server 640.

The time measurement card (category #1), a time measurement card (category #2), a time measurement card (category #3), and a time measurement card (category #n) may be present, and the time may be measured for each category which is set according to the insertion of the time measurement card.

Accordingly, it is possible to measure the immersion time by category, and comprehensive immersion time management may be performed based on the immersion time by category. In the same manner, the information about the immersion time of the user by category may be provided to the user through the timer application of the user device 620. In addition, the analysis information about the immersion pattern by category of the user, the correction information about the immersion pattern, or the like may be provided to the user through the timer application.

Further, according to the embodiment of the present invention, the timer 600 may be synchronized with the user device 620. When a start button (or an operation button) of the timer 600 is pressed, the timer 600 may be synchronized with the user device 620 of the user to block some operations of the user device 620. For example, when the start button of the timer 600 is pressed, the user device 620 may be automatically switched to a concentrated mode, and a function of blocking a short message service (SMS) message, a call, or the like, which is transmitted through the user device 620, may be performed.

Further, the user device 620 may automatically transmit an SMS reply, such as “Currently in an immersion mode (Currently cannot receive calls or messages). I will reply shortly,” in response to the call or message transmitted while using the timer.

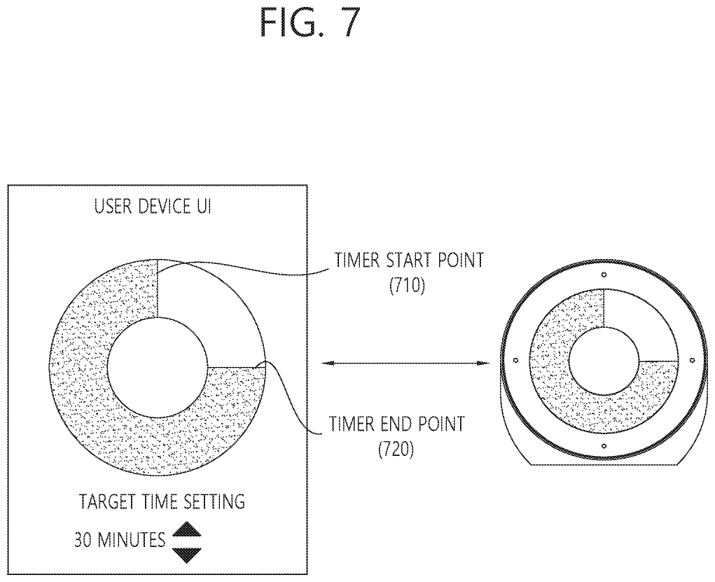

FIG. 7 is a conceptual diagram illustrating a method of setting a timer display according to an embodiment of the present invention.

In FIG. 7, a method of changing movement of a first time display structure and/or a second time display structure displayed on a timer display is disclosed.

Referring to FIG. 7, a start point and end point of a timer may be determined according to a user's setting.

For example, the start point and the end point may be set through a user interface of an application, and a target time may also be set. A time change interval may be set based on the set start point, the end point, and the target time, and the movement of the first time display structure and/or the second time display structure displayed on the timer display may be changed according to the time change interval.

Further, initial positions of the first time display structure and/or the second time display structure may be set according to a set timer start point 710 and a set timer end point 720. For example, initial positions of a first connection point and a second connection point are set as start points so that the first time display structure and/or the second time display structure may be rotated from the timer start point 710 to the timer end point 720.

According to the embodiment of the present invention, the set timer start point 710 and the timer end point 720 may be displayed on the timer through a timer application of a user device. Specifically, information about the set timer start point 710 and information about the timer end point 720 may be transmitted through the user device, and the timer start point 710 and the timer end point 720 may be visually displayed.

Further, according to the embodiment of the present invention, a timer region may be divided into a plurality of regions and used.

For example, when the user wants to divide a time into a plurality of time intervals, such as 50 minutes, 10 minutes, 50 minutes, and 10 minutes, division into a plurality of times may be performed through the user device. Specifically, the time intervals to be divided through the application may be set as a first time interval, a second time interval, a third time interval, and a fourth time interval. Based on pieces of information about the first time interval, the second time interval, the third time interval, and the fourth time interval, an entire timer region may be divided into a first time division region, a second time division region, a third time division region, and a fourth time division region.

The first time division region (start and end points), the second time division region (start and end points), the third time division region (start and end points), and the fourth time division region (start and end points) may be set in consideration of an amount of time through the timer application on the user device.

The first time division region (start and end points), the second time division region (start and end points), the third time division region (start and end points), and the fourth time division region (start and end points) may be displayed on the timer. Separate start and end points may be displayed on the timer display.

According to the start of the timer, the time may be counted while the time display region is changed on the first time division region (start and end points) during the first time interval.

Thereafter, the time may be counted while the time display region is changed in the second time division region (start and end points) during the second time interval, the time may be counted while the time display region is changed in the third time division region (start and end points) during the third time interval, and the time may be counted while the time display region is changed in the fourth time division region (start and end points) during the fourth time interval.

Using the above method, the user may set a plurality of different times in the timer and visually check the plurality of different times on a single screen of the timer.

Alternatively, according to the embodiment of the present invention, the time division regions may be set, and rotation speeds of the first time display structure and/or the second time display structure may be set to be different for each time division region. For example, the first time division region may be set to move one degree per minute and the second time division region may be set to move five degrees per minute, and thus the rotation speeds of the first time display structure and/or the second time display structure that rotate in each region may be set to be different as necessary.

The additional third time display structure described above may be used to display the time division region. The first time display structure and the second time display structure may be used to display the divided regions, and the third time display structure may be used to display a change in time in the divided regions. A region corresponding to the first time division region may be set to be displayed in white through the first time display structure and the second time display structure, and the change in time may be displayed while the third time display structure moves to green in the first time division region. That is, the first time display structure and the second time display structure may display a timer start region and a timer end region in the divided regions, and the flow of time may be visually displayed while the third time display structure is rotated as time passes.

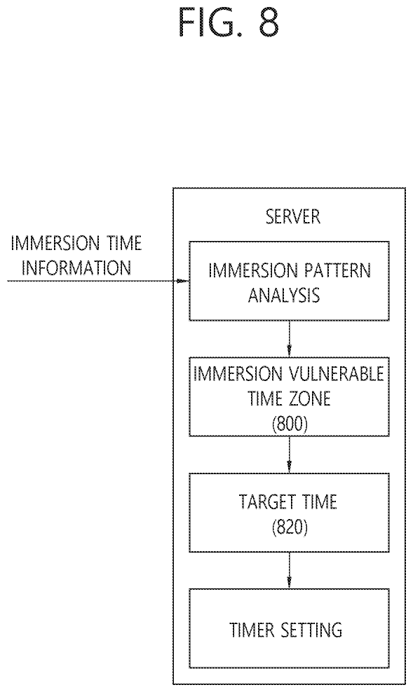

FIG. 8 is a conceptual diagram illustrating a method of correcting an immersion time based on a timer according to an embodiment of the present invention.

Referring to FIG. 8, as described above, the information about the immersion time of the user may be provided to the user through the timer application of the user device.

Further, the information about the immersion time of the user may be provided to the user through the timer application, and the analysis information about the immersion pattern of the user, the correction information about the immersion pattern, or the like may also be provided.

A server may analyze the immersion pattern of the user. The analysis of the immersion pattern may be performed in consideration of information analysis of the immersion time of the user for each time zone, a length of the immersion time, and a frequency of the immersion time, or the like.

For example, a pattern may be analyzed, such as the user having a relatively long immersion time in the morning, and the length of the immersion time becoming shorter into the evening or the length of the immersion time becoming longer before and after lunch.

For accuracy of analysis of the immersion pattern, a time period may be divided and an immersion degree may be determined for each time period. In order to analyze the immersion pattern of the user, the existing information about the immersion time of the user may be collected. A plurality of time periods may be set, and low-priority immersion time pattern information of the user may be extracted from the plurality of time periods. When a first time period is between 9 AM and 11 AM, a low-priority immersion time of the user may be extracted from the corresponding time period. The low-priority immersion time pattern information may be information about the immersion time and information about break time, such as a pattern of one hour of immersion, 20 minutes of break, and 40 minutes of immersion, a pattern of 50 minutes of immersion, 5 minutes of break, one hour of immersion, and 5 minutes of break, or the like.

Among the low-priority immersion times, low-priority immersion times having a threshold percentage of a maximum value and a threshold percentage of a minimum value are excluded, and the immersion time of the time period may be determined by an average of values of the remaining immersion times.

In this case, the plurality of time periods are not simply divided but may be grouped into time periods having similar patterns through clustering of immersion patterns of users. For example, when many similar immersion patterns are seen between 1 PM and 3 PM, the corresponding time period may be grouped into one time period. That is, the time period may be divided for each characteristic of the immersion pattern of the user.

Based on the analysis result, the server may determine an immersion vulnerable time zone 800 in which the user's immersion is vulnerable and may set the timer differently in the immersion vulnerable time zone. For example, in the immersion vulnerable time zone 800, a target time for increasing the immersion of the user may be set and the timer may be set according to the target time. For example, in the immersion vulnerable time zone 800, when the immersion time is 15 minutes, a target time 820 may be set to 200% of the immersion time to allow the user to immerse in the immersion vulnerable time zone 800 for 30 minutes.

Further, the immersion vulnerable time zone of the user may be analyzed so that the target time may be adaptively set according to the immersion vulnerable time of the user. Time table information that is effective to improve immersion degrees of other users who have immersion vulnerable time zones similar to the existing user may be learned and the immersion vulnerable time zone of the user may be analyzed so that the target time may be adaptively set.

In this way, the target time 820 may be set such that the user can further immerse him or herself in the immersion vulnerable time zone 800, and the timer may be set according to the target time 820. In this way, the user may divide an entire time zone in which the timer can be used and effectively distribute the immersion time, and the rotation speed of the first time display structure and/or the second time display structure may be determined according to the time of the divided time zone.

When the time zone is not the immersion vulnerable time zone 800, the target time 820 may be set based on the existing immersion pattern, and the timer may be set according to the target time 820.

That is, on the timer application of the user device, the target time of the timer for the personal schedule may be set according to the immersion pattern of the user and thus may aid the user in immersion for the target time based on the timer.

According to the embodiment of the present invention, a deadline may be managed based on such a timer. Specifically, in a deadline management method, the timer may be combined with other communication devices so that Internet of Things (IoT) based services may be provided. The timer may be combined with devices (e.g., timers, cell phones, artificial intelligence speakers, smart watches, interphones, etc.) of other users.

Specifically, the deadline may be managed by the user by communicating with the timer. Information about the deadline set by the user may be transmitted to the timer through the application. The timer may receive the information about the set deadline and visually provide the information about the set deadline by being set according to the information about the deadline.

The timer may communicate with the highest-priority deadline and provide an alarm to the user so as to process the deadline.

Hereinafter, in an embodiment of the present invention, a method of determining a priority of a deadline is disclosed.

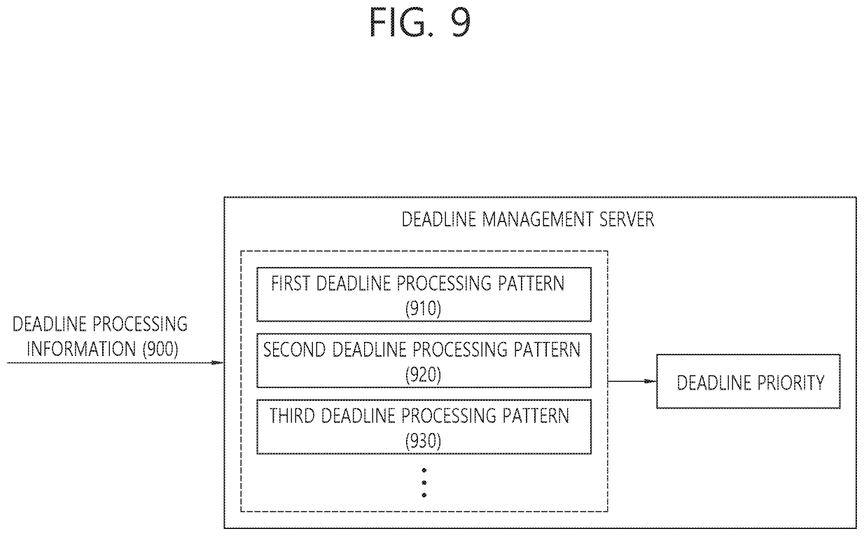

FIG. 9 is a conceptual diagram illustrating a method of providing an alarm for a deadline in a timer according to an embodiment of the present invention.

In FIG. 9, a method of determining a priority of a deadline in order to provide an alarm for a deadline through a timer in a deadline management application that can communicate with the timer is disclosed.

Referring to FIG. 9, the deadline management application may determine importance of each deadline and set a priority of the deadline.

For example, the importance of the deadline may be determined in consideration of a pattern in which deadline processing is performed for each deadline. In the embodiment of the present invention, a deadline processing pattern based on the deadline may be determined in order to determine the importance of each deadline. A deadline management server may collect deadline processing information 900 for processing a deadline based on deadlines of users and determine a deadline processing pattern.

The deadline management server may classify and manage the deadline processing pattern for each deadline as a first deadline processing pattern 910, a second deadline processing pattern 920, or a third deadline processing pattern 930. The deadline processing pattern may be determined based on a first ratio of pre-processing users who have pre-processed the deadline to all users who need to manage the deadline at a time point before the deadline, a second ratio of post-processing users who have post-processed the deadline to all users who need to manage the deadline at a time point after the deadline, and a third ratio of users who did not process the deadline to all users.

For example, the first deadline processing pattern 910 may be a deadline processing pattern in which the pre-processing users corresponding to a first threshold percentage of all users process the deadline before the deadline, the post-processing users corresponding to a second threshold percentage of all users process the deadline after the deadline, and the users corresponding to a third threshold percentage of all users do not process the deadline.

The second deadline processing pattern 920 may be a deadline processing pattern in which the pre-processing users corresponding to a fourth threshold percentage of all users process the deadline before the deadline, the post-processing users corresponding to a fifth threshold percentage of all users process the deadline after the deadline, and the users corresponding to a sixth threshold percentage of all users do not process the deadline. Here, the fourth threshold percentage may be smaller than the first threshold percentage, the fifth threshold percentage may be greater than the second threshold percentage, and the sixth threshold percentage may be greater than the third threshold percentage.

The third deadline processing pattern 930 may be a deadline processing pattern in which the pre-processing users corresponding to a seventh threshold percentage of all users process the deadline before the deadline, the post-processing users corresponding to an eighth threshold percentage of all users process the deadline after the deadline, and the users corresponding to a ninth threshold percentage of all users do not process the deadline. Here, the seventh threshold percentage may be smaller than the fourth threshold percentage, the eighth threshold percentage may be smaller than the fifth threshold percentage, and the ninth threshold percentage may be greater than the sixth threshold percentage.

Based on the above deadline processing patterns, it may be determined that the users process the corresponding deadline with relation to how much importance the deadline has, and the priority of the deadline may be determined. A high priority may be assigned to the deadline when the deadline is processed relatively earlier than the deadline, a low priority may be assigned to the deadline when the deadline is processed relatively later than the deadline, and a relatively low priority may be assigned to the deadline when the deadline is not processed.

Alternatively, as described above, the priority with respect to the deadline processing pattern may be assigned to the deadline based on a first weight of the first ratio of the pre-processing users who have pre-processed the deadline to all users who need to manage the deadline at a time point before the deadline, a second weight of the second ratio of the post-processing users who have post-processed the deadline to all users who need to manage the deadline at a time point after the deadline, and a third weight of the third ratio of the users who did not process the deadline to all users. The first weight, the second weight, and the third weight may be determined in consideration of additional amount information that is generated when the deadline is over (hereinafter, referred to as additional amount information), information on whether or not to stop the service that is generated when the deadline is over (hereinafter, referred to as service interruption information), and information about the user's service usage (hereinafter, referred to as user service usage information). The additional amount information and the service interruption information may be provided from an external deadline collection server which provides a service. The user service usage information may be determined based on accumulated records of how much the user has used the service.

Based on the priority of each deadline, an alarm having the highest-priority deadline may be provided through the timer. The priority of the deadline may be adaptively and continuously changed according to the processing of the deadline by the user.

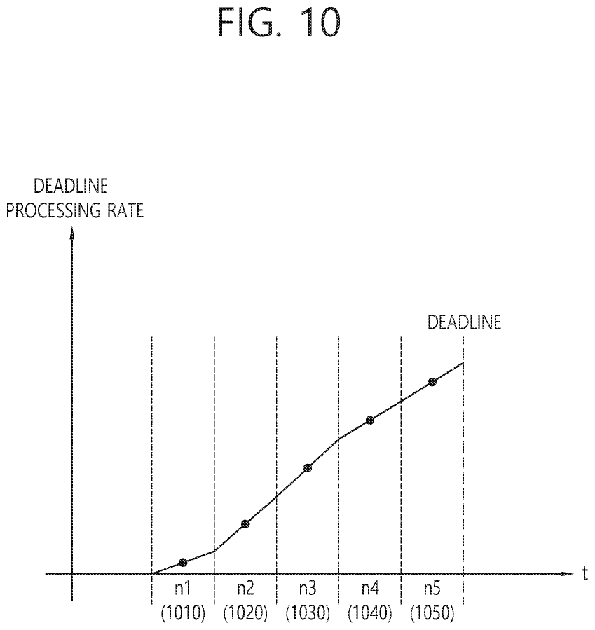

FIG. 10 is a conceptual diagram illustrating a method of determining a priority of a deadline according to an embodiment of the present invention.

In FIG. 10, the method of determining a priority for each deadline is disclosed.

Referring to FIG. 10, the deadline management application may determine the priority of the deadline by determining the tendency of how rapidly the deadline is processed in order to determine the priority for each deadline.

A processing rate for the deadline processed by the user may be increased as a time point earlier than the deadline approaches the deadline. A relatively high priority may be assigned to the deadline when the number of users who pre-process before the time does not approach the deadline is greater than the number of users who process when the time approaches the deadline.

In order to determine the priority of the deadline, the time from the notification time to the deadline time point may be divided into n sections, and the processing rate of the user for each of n sections may be calculated. When n is 5, the processing rate of the user may be calculated in each of an n1 section 1010, an n2 section 1020, an n3 section 1030, an n4 section 1040, and an n5 section 1050. The pre-processing rate of the user may be determined, such as a 10% processing rate in the n1 section, a 25% processing rate in the n2 section, a 50% processing rate in the n3 section, a 70% processing rate in the n4 section, and a 90% processing rate in the n5 section. In consideration of changes in the pre-processing rates, the priority of the deadline may be set to be relatively higher as the processing rate of the user with respect to the deadline relatively before the deadline is increased.

Specifically, in consideration of an initial value of the n1 section 1010, a first ratio going from the n1 section 1010 to the n2 section 1020, the second ratio of going from the n2 section 1020 to the n3 section 1030, the third ratio of going from the n3 section 1030 to the n4 section 1040, and the fourth ratio of going from the n4 section 1040 to the n5 section 1050, the priority of the corresponding deadline may be set to become relatively higher as the initial value and initial ratios such as the first ratio and the second ratio become relatively higher.

The section division may be set differently according to the similarity of the pattern for each deadline that should determine the priority.

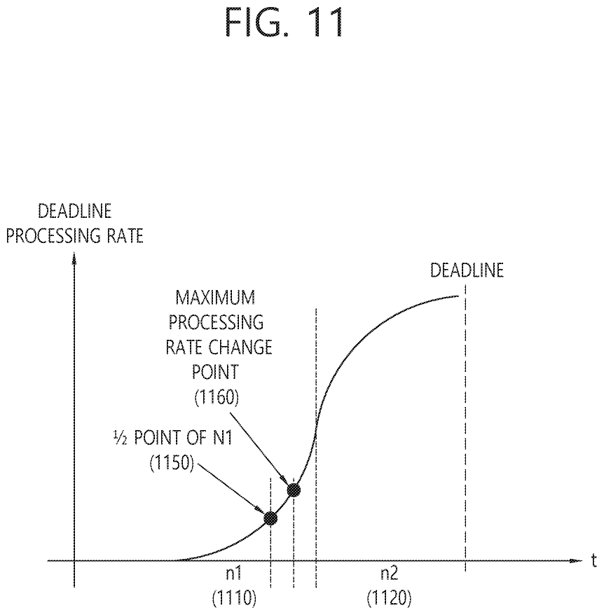

FIG. 11 is a conceptual diagram illustrating a method of determining a priority of a deadline according to an embodiment of the present invention.

In FIG. 11, a method of dividing a section according to similarity of a pattern for each deadline that should determine a priority is disclosed.

Referring to FIG. 11, in order to determine a processing priority of a plurality of deadlines, primary section division may be performed.

In the primary section division, the section may be divided into two sections, and the section before the deadline may be divided into two sections (n1 and n2 sections).

After the division into two sections, a pre-processing rate of each of the n1 section 1110 and the n2 section 1120 may be determined.

When the pre-processing rate of each of the n1 section 1110 and the n2 section 1120 is similar within a set similar threshold range based on the primary section division, additional secondary section division may be performed.

In the secondary section division, the section division may be performed on a section having a greater difference in the pre-processing rate among the n1 section 1110 and the n2 section 1120. When a difference in the pre-processing rate of the n1 section 1110 is greater than a difference in the pre-processing rate of the n2 section 1120), the section division may be performed on the n1 section 1110.

The section division of the n1 section 1110 may be divided based on a ½ point 1150 or a maximum processing rate change point 1160 of the n1 section 1110. First, when a first deadline and a second deadline are objects of the secondary section division, a ½ point 1150 or a maximum processing rate change point 1160 of each of the first deadline and the second deadline may be extracted, and a period between the ½ point 1150 and the maximum processing rate change point 1160 may be determined. When the period between the ½ point 1150 and the maximum processing rate change point 1160 is less than or equal to a threshold percentage of the n1 section 1110, the n1 section 1110 may be divided based on the maximum processing rate change point. Conversely, when the period between the ½ point 1150 and the maximum processing rate change point 1160 is greater than the threshold percentage of the n1 section 1110, the n1 section 1110 may be divided based on the ½ point 1150.

Through the division, it is possible to more rapidly extract and compare characteristics of the pre-processing rate of the deadline.

The above-described embodiments of the present invention may be implemented as the form of a computer instruction that can be executed through various computer components and may be recorded in computer readable recording media. The computer readable recording media may include a program instruction, a data file, and a data structure, and/or combinations thereof. The program instruction recorded in the computer readable recording media may be specially designed and prepared for the present invention or may be an available well-known instruction for those skilled in the field of computer software. Examples of the computer readable recording media include, for example, magnetic media such as a hard disk, a floppy disk, and a magnetic tape, optical media such as a compact disc read only memory (CD-ROM) and a digital video disc (DVD), magneto-optical media such as a floptical disk, and a hardware device, such as a read only memory (ROM), a random access memory (RAM), or a flash memory, that is specially made to store and perform the program instruction. Examples of the program instruction may include a machine code generated by a compiler and a high-level language code that can be executed in a computer using an interpreter. Such a hardware device may be configured as at least one software module in order to perform operations of the present invention and vice versa.

While the present invention has been described with reference to specific details such as detailed components, specific embodiments and drawings, these are only examples to facilitate overall understanding of the present invention and the present invention is not limited thereto. It will be understood by those skilled in the art that various modifications and alterations may be made.

Therefore, the spirit and scope of the present invention are defined not by the detailed description of the present invention but by the appended claims and encompass all modifications and equivalents that fall within the scope of the appended claims.

1. A timer configuring method comprising:
receiving, by a timer, a target time; and
changing, by the timer, an area of a time display region on the basis of the target time and counting the target time,
wherein the area of the time display region is changed by rotation of a plurality of time display structures.

2. The timer configuring method of claim 1, wherein the target time is set based on time setting information transmitted from a time setting card inserted into the timer.

3. The timer configuring method of claim 2, wherein:
the plurality of time display structures include a first time display structure and a second time display structure;
the first time display structure includes a first connection point;
the second time display structure includes a second connection point; and
the area of the time display region is changed by locating a first surface of the first time display structure on an upper end of a second surface of the second time display structure on the basis of the first connection point and the second connection point according to a rotation angle by the rotation of the first time display structure and the second time display structure.

4. The timer configuring method of claim 3, wherein the timer changes a rotation speed of the first time display structure or the second time display structure according to the time setting card.

5. A timer comprising:
a communication unit implemented to receive a target time; and
a timer driver implemented to change an area of a time display region on the basis of the target time and count the target time,
wherein the area of the time display region is changed by rotation of a plurality of time display structures.

6. The timer of claim 5, wherein the target time is set based on time setting information transmitted from a time setting card inserted into the timer.

7. The timer of claim 6, wherein:
the plurality of time display structures include a first time display structure and a second time display structure;
the first time display structure includes a first connection point;
the second time display structure includes a second connection point; and
the area of the time display region is changed by locating a first surface of the first time display structure on an upper end of a second surface of the second time display structure on the basis of the first connection point and the second connection point according to a rotation angle by the rotation of the first time display structure and the second time display structure.

8. The timer of claim 7, wherein the timer driver changes a rotation speed of the first time display structure or the second time display structure according to the time setting card.
